(19) United States
(12) Patent Application Publication
(10) Pub. No.: US 2007/0045951 A1
(43) Pub. Date: Mar. 1, 2007

(54) Video game mask

(76) Inventors: Phillip J. Robertson, SHERMAN OAKS, CA (US); Jesse Singer, Los Angeles, CA (US)

Correspondence Address: CHRISTIE, PARKER & HALE, LLP, PO BOX 7068, PASADENA, CA, 91109-7068, US

(21) Appl. No.: 10/546,124

(22) PCT Filed: Feb. 23, 2004
(86) PCT No.: PCT/US04/05263

§ 371 Date: Sep. 21, 2006

Related U.S. Application Data
(63) Continuation of application No. 10/371,402, filed on Feb. 21, 2003, now abandoned.
(63) Continuation of application No. 10/728,717, filed on Dec. 5, 2003, now abandoned.
Application No. 10/728,717 is a continuation-in-part of application No. 10/371,402, filed on Feb. 21, 2003, now abandoned.
Application No. PCT/US04/05263 is a continuation of application No. 10/738,625, filed on Dec. 17, 2003, now abandoned.
Application No. 10/738,625 is a continuation-in-part of application No. 10/728,717, filed on Dec. 5, 2003, now abandoned.
Application No. 10/728,717 is a continuation-in-part of application No. 10/371,402, filed on Feb. 21, 2003, now abandoned.

(51) Int. Cl. A63F 13/02

(52) U.S. Cl. 273/148 B

(57) ABSTRACT

A mask is mounted on a video game controller to enhance the interaction of its graphics with the game player and the graphic effect of the game. The controller has a curved contour and the shape of the mask matches the contour so the mask its over the surface of the controller. The mask also has openings or windows for providing access to the buttons/rollers for operating the controller. Attachment means secures the mask to the controller. Locating means positions the mask so the openings or windows therein remain aligned with the buttons/rollers. Preferably, graphics in the form of game instructions and/or game related theme imagery are applied to the surface of the mask. To increase the surface area of the mask for the graphics it can be provided with an integral overhang or a separate visor.

### CROSS REFERENCE TO RELATED APPLICATIONS

This application is a continuation-in-part of application Ser. No. 10/738,625 filed Dec. 17, 2003, which is a continuation-in-part of application Ser. No. 10/728,717 filed Dec. 5, 2003, which is a continuation-in-part of application Ser. No. 10/371,402 filed Feb. 21, 2003. The contents of these applications are all incorporated herein by reference.

### BACKGROUND OF THE INVENTION

This invention relates to video games, and more particularly to an accessory for a video game controller.

Video games have created a new culture that consumes video game players. An important part of the success of a video game is its graphics and the interaction of the graphics with the game players.

### SUMMARY OF THE INVENTION

According to the invention a mask is mounted on a video game controller to enhance the interaction of its graphics with the game player and the graphic effect of the game. The controller has a curved contour and the shape of the mask matches the contour so the mask fits over the surface of the controller. The mask also has openings or windows for providing access to the buttons/rollers for operating the controller.

A feature of the invention is attachment means for securing the mask to the controller.

Another feature of the invention is locating means for positioning the mask so the openings or windows therein remain aligned with the buttons/rollers.

Preferably, graphics in the form of game instructions and/or game related theme imagery are applied to the surface of the mask. To increase the surface area of the mask for the graphics it can be provided with an integral overhang or a separate visor.

### BRIEF DESCRIPTION OF THE DRAWINGS

The features of specific embodiments of the best mode contemplated of carrying out the invention are illustrated in the drawings, in which:

### DETAILED DESCRIPTION OF THE INVENTION

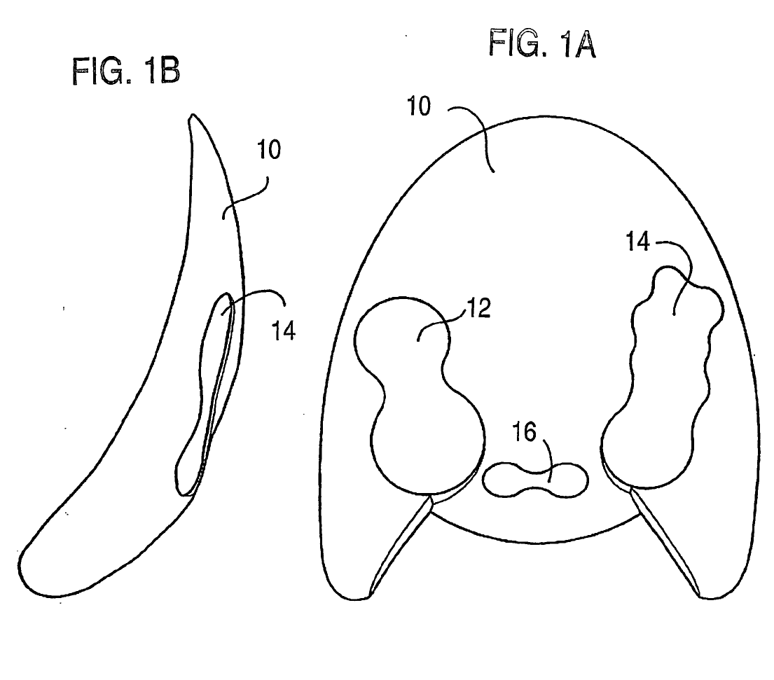

In FIGS. 1A and 1B a mask 10 is shaped to match the curved contour of a video game controller such as a Microsoft X-BOX (not shown). Mask 10 has openings 12, 14, and 16 that are in registration with the control buttons/knobs on the controller, which are accessible to a game player when mask 10 is mounted on the controller. Depending on the circumstances, mask 10 could be made of a rigid or non-rigid material, such as plastic, metal, rubber, cardboard, etc.—for example, a non-rigid plastic for a form-fitting mask, cardboard for a relatively low priced mask, and metal for a space age mask. As discussed in more detail below, graphics in the form of game instructions, game related theme imagery, advertisements, and/or textured surfaces are preferably printed, molded into, or otherwise applied to the exposed surface of mask 10

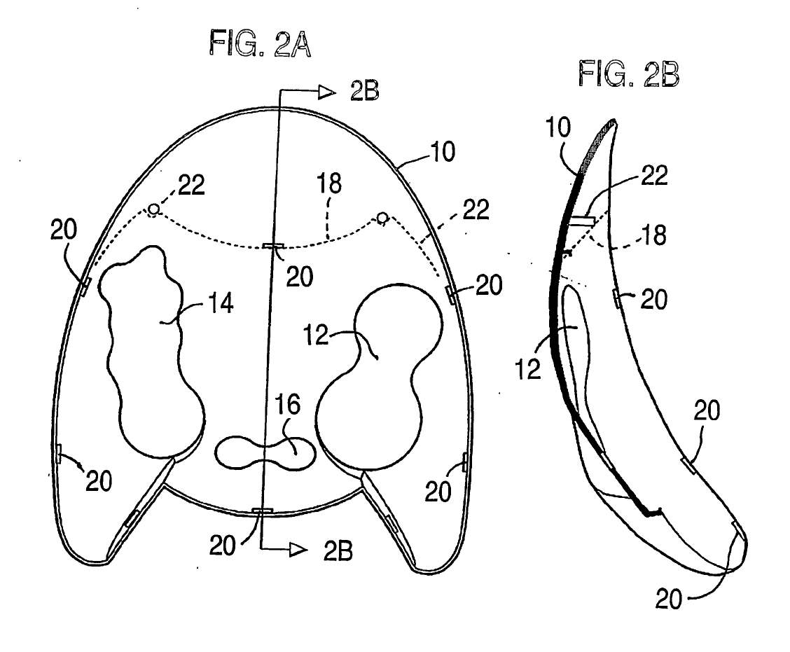

In FIGS. 2A and 2B mask 10 is mounted on a video game controller 18, represented in broken lines. Note that an overhang at the front of mask 10 extends beyond the front of controller 18 in cantilever fashion to expand the surface area or “real estate” available for graphics. (In this embodiment, mask 10 must be made of a material with sufficient rigidity and strength to support itself when cantilevered.) Since controller 18 has a curved contour, mask 10 has means for attachment to controller 18. In FIGS. 2A and 2B the attachment means are spring tabs 20 that are distributed around the periphery of mask 10. When mask 10 is fitted on controller 18, tabs 20 are deformed by the periphery of controller 18 and retained there by the return spring force. In this embodiment mask 10 has locating posts 22, which retain the back of controller 18 against the back of mask 10 and align (See post 22 bearing against the top surface of controller 18 in FIG. 2B.)

Many other types of attachment means could be used, some of which are illustrated in other disclosed embodiments. For example, if mask 10 is non-rigid, it can wrap around the surface of controller 18 so it must be peeled off to remove. Or mask 10 could be retained by static electrical attraction.

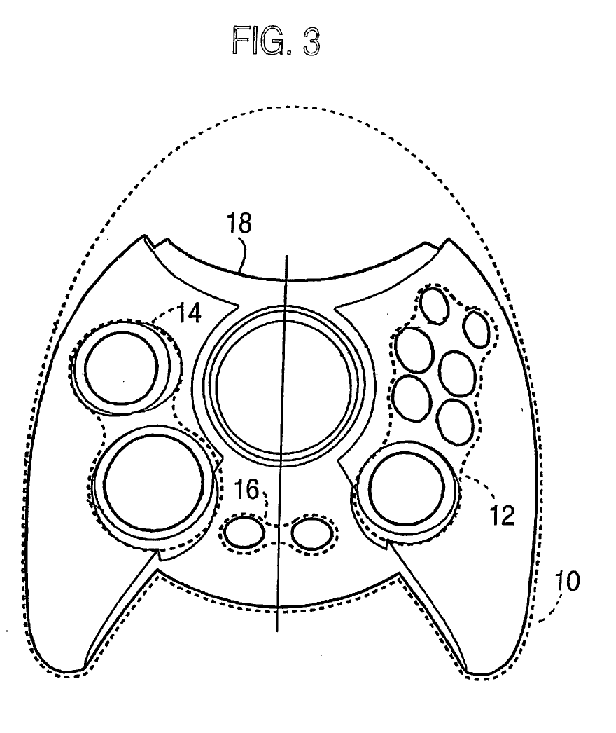

In FIG. 3 mask 10 is represented in broken lines overlying controller 18. The control buttons/knobs on controller 18 are accessible through openings 12, 14, and 16.

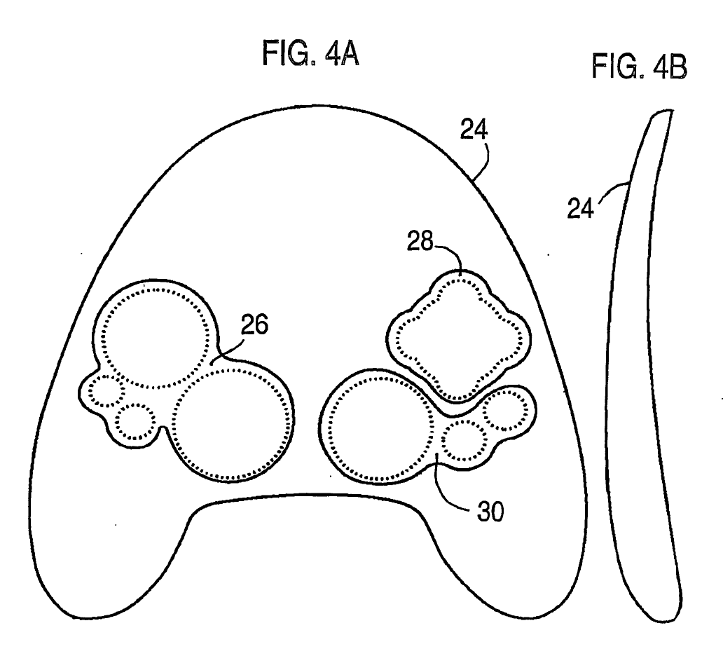

In FIG. 4, a mask 24 is designed for an X-BOX S controller. Openings 26, 28, and 30 provide access to the control buttons/rollers on the X-BOX S controller.

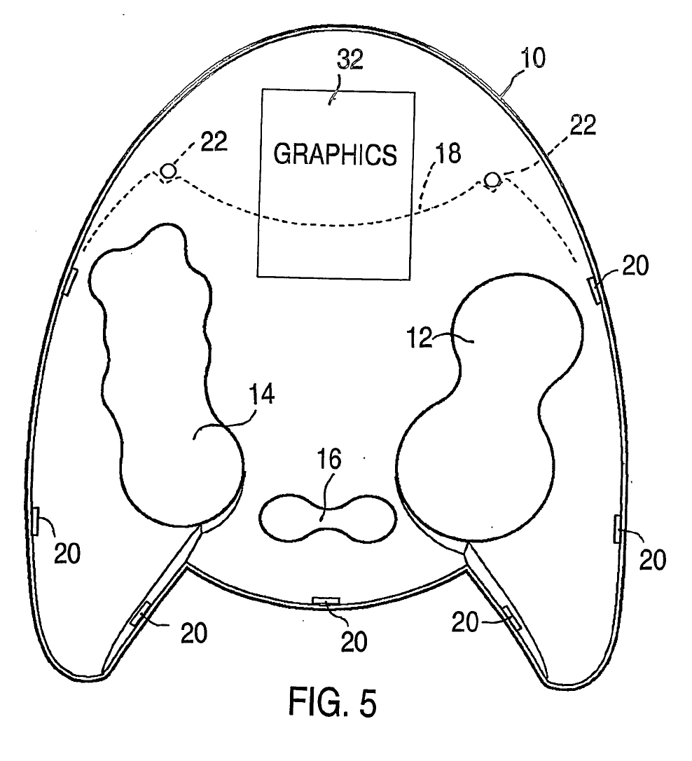

In FIG. 5, graphics are applied to an area 32 the mask of FIG. 2A. It is particularly advantageous to apply game instructions as the graphics in area 32 for ease of reference by the game player during game play. The graphics could also include advertisements and images relating to the theme of the game. Further, instead of being concentrated in area 32, game instructions and/or labels identifying the function of control buttons/rollers could be distributed at different locations on mask 10.

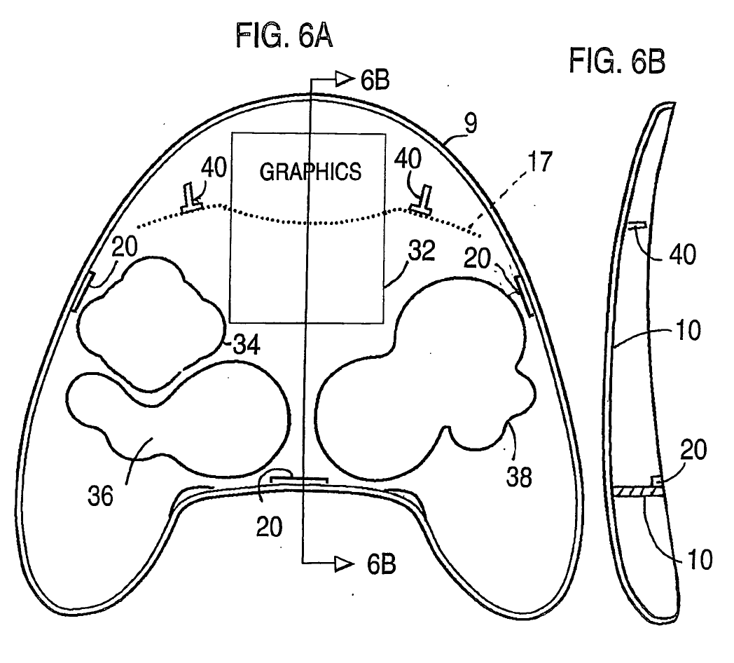

In FIGS. 6A and 6B a mask 9 has different attachment and locating means and openings 34, 36, and 38 for access to the buttons/rollers on a Nintendo GAMECUBE controller 17. Specifically, stops 40 on mask 9 serve to position mask 9 relative to controller 17 and together with deformed spring tabs 20 to retain mask 9 on controller 17.

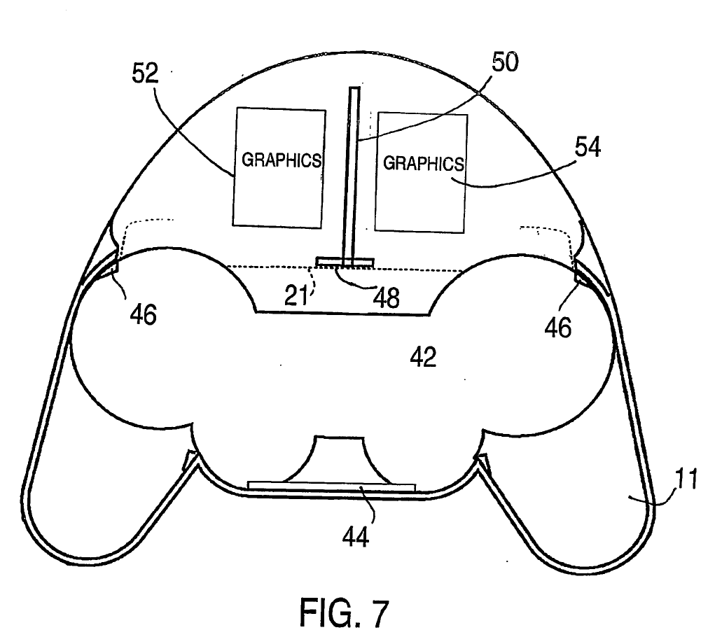

In FIG. 7 mask 11 has a single opening 42 that provides access to all the buttons/rollers. A spring tab 44 together with stops 46 and 48 on mask 11 retain a Sony PLAYSTATION controller 21. A beam 50 supports the overhang of mask 11 so it does not sag. Graphics are displayed in areas 52 and 54.

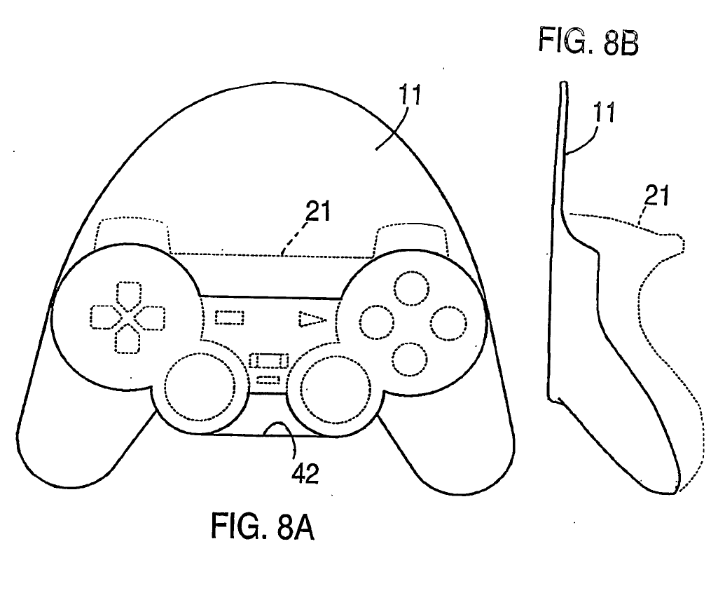

In FIGS. 8A and 8B the outline of controller 21 is shown in broken lines relative to mask 11. In FIG. 8A the position of the buttons/rollers can be seen inside opening 42. In FIG. 8B the overhang of mask 11 and how it partially covers the handles of controller 21 are illustrated.

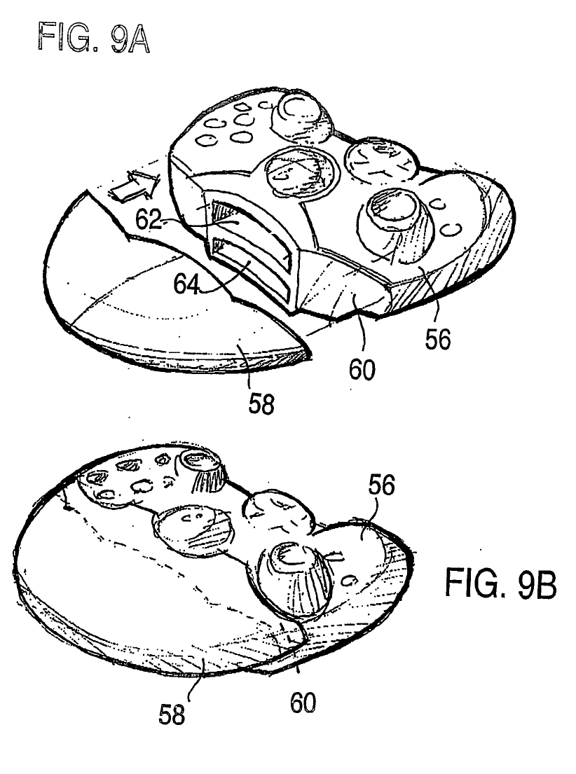

In FIGS. 9A and 9B a mask 56 has a separate visor 58 that covers the front of an X-BOX S controller 60. As shown in FIG. 9A controller 60 has slots 62 and 64 adapted to receive memory cartridges. As shown in FIG. 9B, visor 58 covers slots 62 and 64 when visor 58 is installed on the front of controller 60. Graphics (not shown) are displayed on the surface of visor 58.

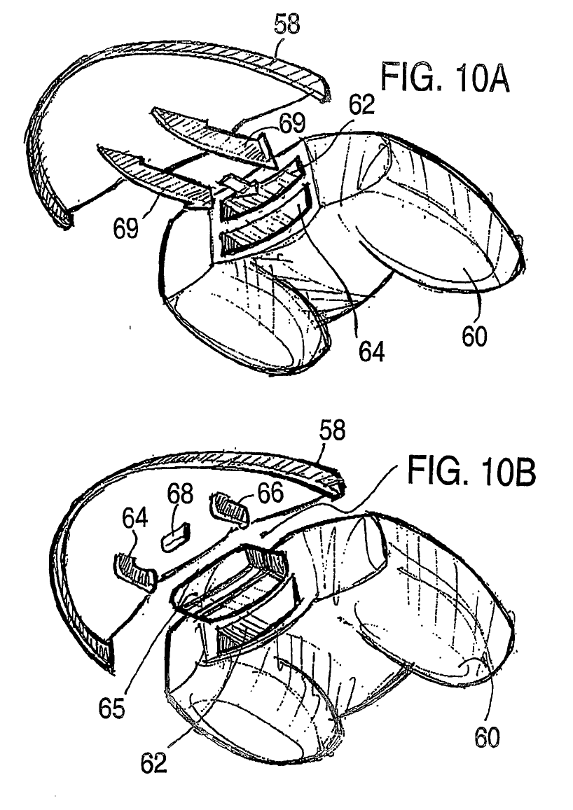

FIGS. 10A and 10B show one embodiment of the attachment and locating means for visor 58 in the form of spring arms 64 and 66 and a stop 68 on visor 58 A memory cartridge 65 is disposed in slot 62. When visor 58 is slid into position at the front of controller 60, as represented by arrows 69 in FIG. 9A, spring arms 64 and 66 are spread out by memory cartridge 65 and movement of visor 58 into slot 62 is limited by stop 68. Spring arms 64 and 66 retain visor 58 on controller 60 and against mask 56 (FIG. 9A).

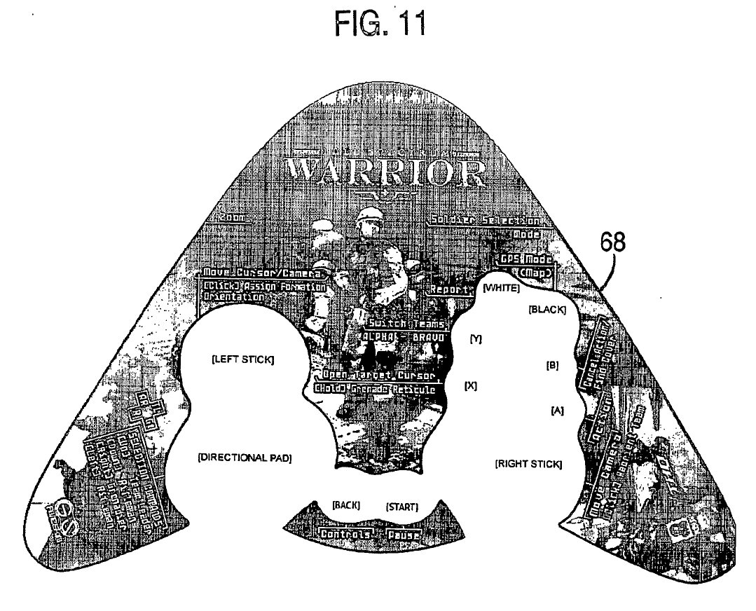

FIG. 11 illustrates typical graphics on a mask 68 for a game called FULL SPECTRUM WARRIOR. The colors on FIG. 11 represent the colors on the buttons/rollers of the controller. Note the game functions in proximity to the respective buttons/rollers and the images relating to the game theme in the background.

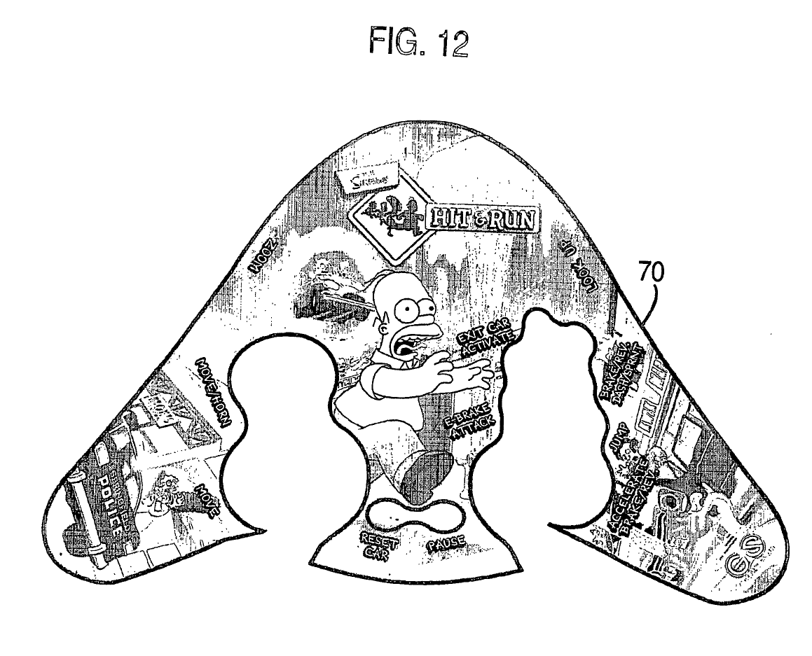

FIG. 12 illustrates typical graphics on a mask 70 for a game called HUT & RUN. Note the game functions in proximity to the respective buttons/rollers and the images relating to the game theme in the background.

Generally, the attachment means is a spring mechanism that is deformed when mounted on controller 18 so the return force of the mechanism retains mask 10 on controller 18. Instead of the illustrated attachment means, the elasticity of mask 10 could be used, i.e., mask 10 could be stretched when mounted on controller 18 and retained by the return force exerted by mask. Alternatively, a separate mechanism could be used to retain mask 10 on controller 18. Although it is preferable to have the attachment means on mask 10, they could be on controller 18 instead.

The controller could be designed to feedback to the game player stimulation relating to events occurring during game play. For example, during a dangerous situation the handle or a button could be heated or vibrated. Many other ways can be designed to impart to the game player sensations relating to the game player's actions during game play.

The described embodiments of the invention are only considered to be preferred and illustrative of the inventive concept; the scope of the invention is not to be restricted to such embodiments. Various and numerous other arrangements may be devised by one skilled in the art without departing from the spirit and scope of this invention. For example, instead of providing openings for access to the buttons/rollers the mask could have windows that permit the buttons/rollers to be operated from outside the controller.

Attached as Appendix A is an outline of a number of alternatives to the described embodiments.

GAMESKIN™ Disclosure

1. Controller Mechanical
a. Attachment Mechanisms
   i. Snaps
   ii. Adhesives
   iii. Other
      1. Suction
      2. Velcro
      3. Preinstalled or applied magnets
      4. Use screws from controller
      5. Cover more of controller—Total or almost completely encompass controller
         a. Multiple parts or hinged snapping door
b. Materials
   i. Plastic
      1. Flexible/Rigid
      2. Varied wall sections—Thick and very thin wall sections would allow for flexible sections
   ii. Rubber
      1. Soft/Hard
      2. Neoprene
      3. Latex
   iii. Metal
      1. Sheet or perforated
   iv. Foam, Styrofoam, Paper,
   v. Dual or multiple materials
      1. Co-molded
      2. Over-molded
      3. Snap-together sections
c. Finish/Texture
   i. In Mold Texture
      1. Simulate Basketball, Baseball, Football, scales, webbing, rough, smooth
   ii. Secondary Manufacturing Process
      1. Total or specific areas have process to alter look and/or feel
      2. Nextel or Rubber paint, gooey, rough, slimy, smooth, scaly, webbed, etc.
      3. Heat/Cold sensitive areas
   iii. Consumer Application
      1. Stick on texture areas
      2. Detents or snap in sections for consumer alter texture or item—web, ears, horns, antenna
      3.
d. Novelty
   i. Glow In the Dark—GAMESKINS™ can illuminate in the dark
   ii. Gel filled for squishiness or push gel from area in pocket to reveal message
e. Design
   i. Current designs
   ii. Solo Visor—GAMESKIN™ can attach via the top of a controller and anchor via the memory cartridge slots.
   iii. Completely cover keys with thin, flexible material
   iv. Other

2. Electrical/Technical
a. Visual
   i. LED
   ii. Light Pipe
   iii. Laser?
b. Sound
   i. A small microphone and speaker can also be imbedded.
   ii. Voice from another player
   iii. Hint voice
      1. Preloaded, consumer recorded or downloaded
      2. Can be prompted to give hint
      3. Password opened for cheat magazine
   iv. Voice altering—“LLLUUKE”
   v. Non-electrical sound makers
c. Feedback
   i. Pain, heat, cold based on input
   ii. Ooze blood, oil, green alien blood, wormy stuff
d. Communication
   i. Keyboard
      1. Extra keys are molded into skin
      2. Extra keys could interface with game or separate environment—chat, call friend, take photo
      3. Pure keyboard just to allow chat during “Live” stuff
      4. Keyboard could unlock hint—get code from . . .
   ii. Communicate with PC/Internet
   iii. Video Screen—GAMESKIN™ can house an LCD video enabled screen via the visor to allow players to visually see and communicate with fellow players. A small microphone and speaker can also be imbedded.
   iv. CCD Camera takes picture of player
   v. Come on—Bluetooth?

3. Graphical/User Interface
a. Top side printing
   i. Silk Screened—GAMESKIN™'s would have graphics and instructional content permanently printed onto the material.
   ii. Etched, raised
b. Underside
   i. Printing, sticker
   ii. Holder for additional things
      1. Pocket, snaps, rails
      2. Stickers, booklet, CD/DVD, cards
c. Electronic Displays
   i. LCD or other type of electronic display
   ii. Content could be refreshed, interchangeable and updated via an internal computer chip within the skin or via an Internet connection relaying information through the OS to the Skin.
   iii. Project image
      1. Laser light pointer
      2. Project words on TV or walls
d. Changeable Printed controls
   i. Reference Card Enabled GAMESKIN™ “Slip In's”—Attachable reference cards that would attached via the visor.
   ii. Alligator Clips—These clips can attach to the controller and hold a reference card
   iii. Secondary coating—scratch off to next level
   iv. Additional stickers are applied
   v. Rotate wheel or slide bar to expose new commands
   vi. Rub heat sensitive ink
e. Stickers with texture for button location, they would be put on buttons or different areas of the skin
   i. User doesn't have to look down
   ii. Spiky sticker on shoot button
   iii. Dots next to pause button

4. Other
a. Attachable Items
   i. Toys
   ii. Light saber
b. Food/Candy
c. Smells
d. View window for secrete codes
   i. Hold window to ad, game or web page to display additional info
e. Transformer—folds into other object
f. Super cheep version could be sticker or cardboard

What is claimed is:

1. A mask for a video game controller having a plurality of actuators, the mask comprising:
a thin plastic non-rigid shell that conforms to the shape of the controller;
means permitting the actuators to be operated from outside the shell; and
a visible actuator guide mounted on the shell to facilitate game play.

2. The mask of claims 1, in which the permitting means comprises openings in the shell in registration with the actuators.

3. The mask of claim 1, in which the guide visually identifies game influencing functions of the actuators.

4. The mask of claim 1, in which the guide has a first visible column that identifies the actuators and a second visible column that identifies game influencing actuator functions, the columns being aligned with each other.

5. The mask of claim 1, additionally comprising means for releasably securing the shell to the controller.

6. The mask of claim 5, in which the securing means comprises flexible integral side panels on the shell that curl around the controller.

7. The mask of claim 1, in which the guide is mounted on the shell with adhesive.

8. The mask of claim 1, in which the guide is secured to the shell by impressions on the surface of the shell.

9. The mask of claim 1, additionally comprising a guide holder on the shell, the guide being mounted on the shell in the guide holder.

10. The mask of claim 9, additionally comprising one of more other guides that can be substituted for the guide in the holder.

11. The mask of claim 1, in which a major portion of the
shell is rigid and the permitting means comprises resilient portions of the shell in registration with the actuators.

12. The mask of claim 1, in which the shell is imprinted with an image suggestive of the game.

13. A set of masks for a video game controller having a plurality of actuators, each mask corresponding to a different video game, each mask comprising:
a thin plastic shell that conforms to the shape of the controller;
means permitting the actuators to be operated from outside the shell; and
a visible actuator guide unique to each video game mounted on the shell to facilitate use of the controller.

14. The mask of claim 1, in which each shell is imprinted with game instructions with a different image suggestive of the game to which its mask corresponds.

15. The mask of claim 14, in which the actuators are color coded and the guides identify actuator functions that are color coded to correspond to the actuators.

16. A method for human operation of a video game controller
having a plurality of actuators, the method comprising:
placing a shell over the controller;
attaching to the shell a guide relating the actuators to game functions; and
operating the actuators to play the game while viewing
